(19) United States
(12) Patent Application Publication
(10) Pub. No.: US 2007/0038520 A1
(43) Pub. Date: Feb. 15, 2007

(54) Method and system for alternative provisioning

(76) Inventors: William Grey, Millwood, NY (US); Steven J. Mastrianni, Unionville, CT (US); Paul A. Moskowitz, Yorktown Heights, NY (US); Clifford A. Pickover, Yorktown Heights, NY (US)

Correspondence Address: David Aker, 23 Southern Road, Hartsdale, NY, 10530, US

(21) Appl. No.: 11/199,958

(22) Filed: Aug. 9, 2005

(51) Int. Cl. G06Q 30/00

(52) U.S. Cl. 705/26

(57) ABSTRACT

A programmed method for supplying content includes receiving via a network a request for a first content for use on a device, from a requester; automatically selecting a second content to fulfill the request; and providing the second content to a source of the request. From the point of view of a requester, the programmed method includes requesting via a network a first content for use on a device; and receiving an automatically selected second content to fulfill the request. The device may be a computer, and the content may be software for use on the computer. Selection may be performed in accordance with predetermined criteria, including predetermined rules. Information defining at least one criterion may be received from at least one requester. The criteria may be based on relatedness of the first content and the second content. Generally, the request is fulfilled via a network.

### BACKGROUND OF THE INVENTION

1. Field of the Invention

The present invention relates to a method, apparatus and software for provisioning in an application service environment. More particularly, it relates to those apparatus, methods and software in which alternative provisioning is accomplished.

2. Background Art

An application service provider (ASP) is a company that offers individuals or enterprises access, generally by using the Internet, to applications and related services that would otherwise have to be located in their own personal or enterprise computers. Sometimes referred to as “apps-on-tap,” ASP services are becoming an important alternative, not only for smaller companies with low budgets for information technology, but also for larger companies as a form of outsourcing and for many services for individuals as well.

In many cases, an ASP is a third-party entity that manages and distributes software-based services and solutions to customers across a network from a central location. ASPs may be commercial entities that serve the needs of paying customers, or not-for-profit or government organizations, providing service and support to end users. Applications include business applications, web site services, and support for specific industries such as healthcare. More generally, an ASP may also distribute content. Examples of end users include engineers, financial analysts, or students.

An application service provider often creates a subscription-based software service. For a periodic fee (usually monthly or yearly) the ASP may provide software (which is sometimes referred to as the generic term “content”) and other computer-based services to users over the Internet or other network mechanism.

An ASP typically provides services that include: 1) access to specialized applications that would be expensive to install and maintain within a company or on a user's own computer, 2) remote access serving for the users of an enterprise, 3) an off-premises local area network to which mobile users can be connected, with a common file server.

Many technology companies have formed alliances for providing ASP services. These companies provide applications over a network on a rental or pay-as-you-use basis.

ASPs may provide applications and services to small enterprises and individuals on a pay-per-use or yearly license basis. Larger corporations often provide their own ASP service in-house, moving applications off personal computers and putting them on a special kind of application server that is designed to supply a user's inexpensive “thin client” workstation. This allows an enterprise to reassert the central control over application cost and usage that corporations formerly had in the period prior to the advent of the PC.

In summary, an application service provider (ASP) is a company that offers individuals or enterprises access, generally via a network, and more specifically via the Internet, to applications and related services that would otherwise have to be located in their own personal or enterprise computers. Sometimes referred to as “apps-on-tap,” ASP services are expected to become an important alternative, not only for smaller companies with low budgets for information technology, but also for larger companies as a form of outsourcing and for many services for individuals as well. Early applications include:
Remote access serving for the users of an enterprise.
An off-premises local area network to which mobile users can be connected, with a common file server.
Specialized applications that would be expensive to install and maintain within your own company or on your own computer.

Hewlett-Packard, SAP, and Qwest have formed one of the first major alliances for providing ASP services. They plan to make SAP's popular R/3 applications available at “cybercenters” that will serve the applications to other companies. Microsoft is allowing some companies to offer its BackOffice products, including SQL Server, Exchange and Windows NT Server on a rental, pay-as-you-use basis.

While ASPs are forecast to provide applications and services to small enterprises and individuals on a pay-per-use or yearly license basis, larger corporations are essentially providing their own ASP service in-house, moving applications off personal computers and putting them on a special kind of application server that is designed to handle the stripped-down kind of thin client workstation. This allows an enterprise to reassert the central control over application cost and usage that corporations formerly had in the period prior to the advent of the PC. Microsoft's Terminal Server product and Citrix's WinFrame products are leading thin-client application server products.

Further background on ASPs can be found at: http://www.stardock.net/media/asp_primer.html.

Thus, although there are many advantages to the use of ASP's, there are also several disadvantages. For example, users of applications and content may sometimes experience an interruption in service, software or content for a variety of reasons—a problem that needs to be solved to increase user satisfaction. In addition, it may be desirable for an end user to switch to a different application to perform the same function, in circumstance where growth has occurred or additional functions must be added. Sometimes simpler or more complex applications must be available to accommodate the changing skill levels of persons hired to use the application. In summary, there is a great need for flexibility in provisioning that often is not met by existing provisioning methods, systems and software.

### SUMMARY OF THE INVENTION

It is an object of the invention to provide a method, apparatus and software for alternate provisioning.

It is a further object of the invention to provide a method, apparatus and software for alternate provisioning that is flexible and responsive to user needs.

It is another object of the invention to provide a method, apparatus and software for alternate provisioning that is responsive to environmental factors such as available bandwidth or interruptions in service.

These objects and others are achieved in accordance with the invention by a programmed method for supplying content, as defined in more detail below, to be one of a process, a computer readable medium having program code thereon for performing a process, or a device programmed to perform the process. The programmed method comprises receiving via a network, a request for a first content for use on a device; selecting, automatically, a second content to fulfill the request; and providing the second content. Generally the second content is provided to a source of the request. The device may be a computer. The request is fulfilled via a network. The network may include any one of Internet, wireless, intranet, Bluetooth, or 802.11.

The first content and the second content may be any of software applications; a service; text files, images, video, streaming video/audio, or electronic books. The second content may be an upgrade of the first content.

The selecting may be performed in accordance with predetermined criteria, which may include predetermined rules. Information defining at least one criterion from at least one requester may be received. The criteria may be based on a relatedness of the first content and the second content. The relatedness may include a different version of the content; and content that performs a similar function. The criteria may comprise any of a lottery selection; a number of times a customer visits a web site; and total usage by the customer or an individual user.

The selecting may be performed by at least one of: a business entity; a government; a photo provider; a music provider, an image provider; an insurance agency; a health provider; an advertiser; a television program listing provider; a broadcaster; and a game provider.

From the point of view of a requester, the invention may have any of the attributes mentioned above, but may also be directed to a programmed method for obtaining content, comprising: requesting via a network a first content for use on a device; and receiving an automatically selected second content to fulfill the request.

Users may also permit an ASP to automatically make application substitutions based on a variety of criteria including availability, cost, human factors, or simply the desire to experience new kinds of software. A “switch provider element” automatically switches from one application or content to another, based on some criteria, and then the system determines the fees associated with the switching.

In the field of education, this invention may be used to automatically provide alternative educational software or content using a number of criteria.

### BRIEF DESCRIPTION OF THE DRAWINGS

The foregoing aspects and other features of the present invention are explained in the following description, taken in connection with the accompanying drawings, wherein:

FIG. 1 is a block diagram of the manner in which the present invention is used in provisioning.

FIG. 2 is a block diagram of the present invention, which includes an ASC or application switch controller.

FIG. 3 is a block diagram of a file or table that contains information on users' requests, alternative applications, and rules used to make the switch between alternative applications.

FIG. 4 is a flow chart that illustrates steps in implementing the application switching service.

### DETAILED DESCRIPTION OF THE PREFERRED EMBODIMENTS

The term “programmed method”, as used herein, is defined to mean one or more process steps that are presently performed; or, alternatively, one or more process steps, that are enabled to be performed, at a future point in time. The term “programmed method” is directed to three alternative forms. First, a programmed method comprises presently performed process steps. Second, a programmed method comprises a computer-readable medium embodying computer instructions, which when executed by a computer performs one or more process steps. Finally, a programmed method comprises a device, such as, but not limited to, a computer system, that has been programmed by software, hardware, firmware, or any combination thereof, to perform one or more process steps. As such, a device may also be a PDA, iPod or other similar device.

It is to be understood that the term “programmed method” is not to be construed as simultaneously having more than one alternative form, but rather is to be construed in the truest sense of an alternative form wherein, at any given point in time, only one of the plurality of alternative forms is present.

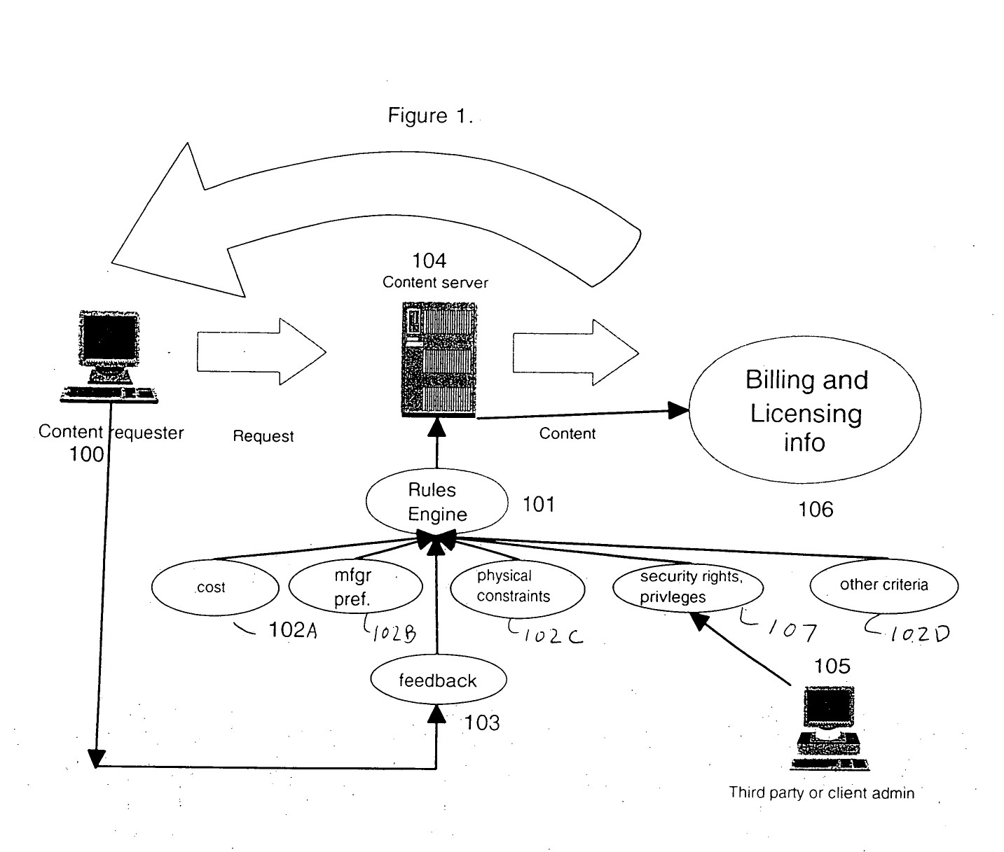

Referring to FIG. 1, there is shown a block diagram of a system incorporating features of the present invention. Although the present invention will be described with reference to the embodiments shown in the drawings, it should be understood that the present invention can be embodied in many alternate forms of embodiments. In addition, any suitable type of elements or components could be used.

Referring to FIG. 1, a content requester 100 requests the use of a particular application by typing the name of a software program to which access is desired. If the program does not exist locally, a request for the program is sent to the content server 104. If the content requester 100 has the required privileges, the application is sent from the content server 104 to the content requester 100. The content server 104 verifies that the content requester 100 has the required authorization to verify it with the rules engine 101. The engine rules 101 checks the various criteria such as cost 102A, manufacturer preferences 102B, physical constraints 102C, and other criteria 102D, to determine if the client qualifies for the software. If so, the rules engine 101 checks the feedback 103 from the client 100 to determine if the installation or use of the requested or related software resulted in any reported problems. If not, the software is delivered to a client at the content requester 100 from the content server 104. The software or content that is delivered may be any combination of scripts, executable code, or links to other systems that contain the whole or parts of the requested application for download or use over the network in a distributed fashion. Additionally, a third party 105 such as a vendor or authorized company representative (client administrator) can amend the client policies with regard to rights or authentication via a security rights and privileges facility 107. Once the application has been delivered, the content server 104 notifies the content provider (not shown) with the appropriate information needed to deal with billing and licensing issues 106, and perhaps other issues such as updates and subscription discounts.

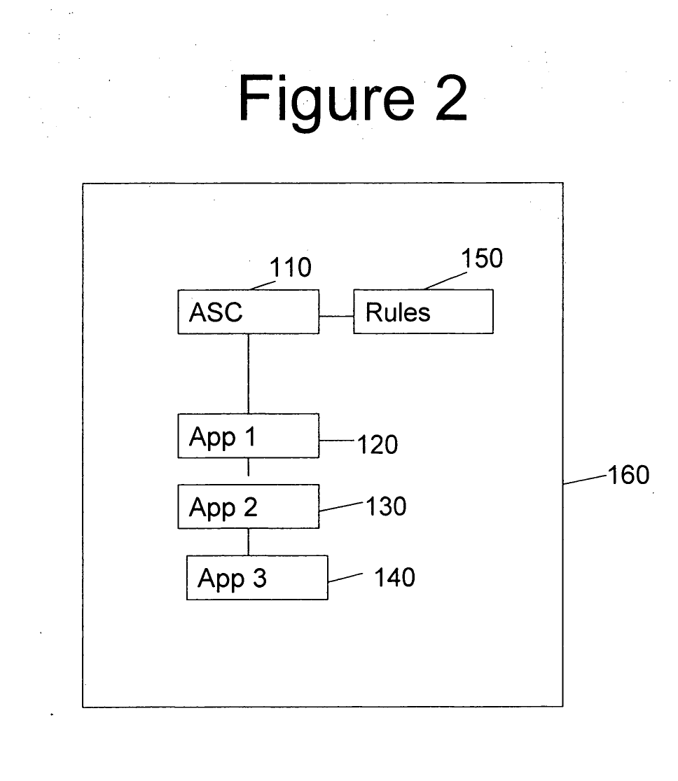

FIG. 2 illustrates an application switch controller ASC 110 that controls the switching to alternative applications 120, 130, 140. A set of rules 150, used by the rules engine 101 (FIG. 1), determine which applications 120 to consider. The ASC 110, applications 120, and rules 150 may reside on a computing resource 160 attached to a network. Computing resource 160 may be on an ASP's server, or located on another computer including the user's or content requester's 100 (FIG. 1) own computer.

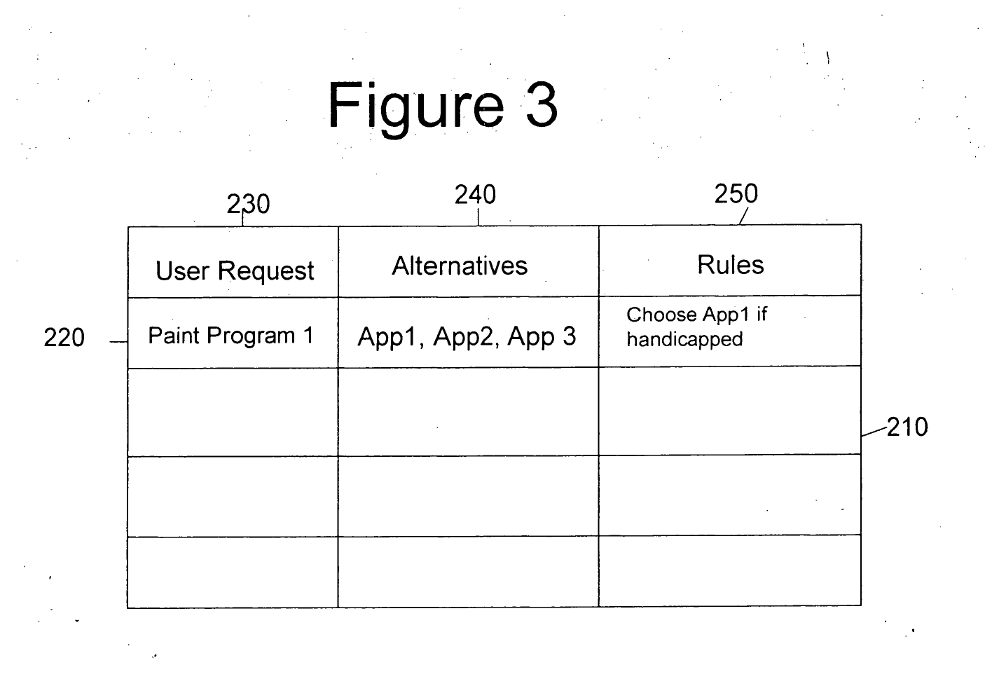

FIG. 3 shows an example of a file or table containing the rules 150 (FIG. 2) that determine which application 120 to consider. The file 210 may include records 220 that map a user requested program or general need 230 to other applications 240 based on rules 250. For example, a rule may be, “If user chooses paint program 1 and he is visually impaired, and enjoys the experience of trying new user interfaces, then the ASC will select application 2.”

The rules 250 that provide criteria for making a choice between many alternatives 240 may be established by numerous means. For example, a user may enter them in response to a survey or questionnaire that has questions relating to physical or cognitive disabilities, willingness to experience new products, price, need for security, and so forth. Alternatively, a company for which a user works may establish the rules in the form of a policy table that may be used to aid the software in determining alternatives. The application switch controller ASC 110 may establish default rules by assessing potential or likely needs as gleaned from a statistical analysis of the user's demographics, such as age, location, gender, and nature of the business. The rules may be established by a third party such as a parent for a child, an employer for an employee, or a guidance counselor for a client. Graphical user interfaces may be provided for rule entry, such as dials that are used to control the decree of desired security or the importance of accessibility for the visually impaired.

As an example, the user's company may have a predetermined provisioning based on the service level, say bronze, silver, gold. This is usually determined or set forth in a contract or service level agreement. The service level may determine the ability of the user to select a particular provisioning scenario, or it may default to a specific level that does not allow the user to make a choice. If a choice is available, the user may not be able to select it, but the IT administrator at the user's company or facility may be able to select it depending on the company's service level. In the case where the provisioning can be selected, the user or administrator is presented with a menu of software to choose from, with optional components and/or applications to be installed.

These policies may be driven by business goals, such as “maximize my profit for the next two weeks”, or “slow production over the next 30days to allow inventories to rise”. The policy level in place may even be ratcheted downward for customers with late payments or for nonpayment. The policy data may be kept in a relational database such as DB2 or stored as a flat file. The policy data may be exported or imported to or from text files, and used to provide a visual text or graphic display of the policy.

General criteria that may be provided as input by a user or requester include any of: low availability of an application or content; cost and/or profit margin of an application or content; speed of first application; quality of first application; and human factors of the applications (e.g. is it good for the handicapped with respect to need to use eyes, ears, hands?); if an application is not enabled for the visually impaired, can an alternative be found that is, such as speech enablement for visually impaired, voice recognition, etc.). Other criteria may include content and values (e.g. is the application your child requested violent or filled with adult content?). Further criteria may be the nature of licenses for the applications (e.g. depending on the licensing terms with the vendor, or the intellectual property rights associated with the application in the target venue, a different application might be selected), operating system and hardware requirements of the applications; language of the application (e.g. text is in German); desire to broaden a customer's experience; ability to collect market data (e.g. customer feedback) ; the vendor of an application; export regulations (e.g. if using abroad, the prohibition on export of applications using 128 bit encryption); customization of the product (e.g. changes in clip art provided, changes in the features provided—i.e. use a “lite” version without certain tools such as hyphenation or spell checking in a word processor under certain conditions); topic; style; reading level; cost; appropriateness; votes by other users; ratings; availability; bandwidth requirements and sensitivity thereto of application 2 is less than application 1; level of security; fewer advertisements; a bidding (auction) system for applications; potential or predicted relative liability over time; relative ease of use for a plurality of providers (e.g. user experience); relative cognitive load (e.g. language of material presented); and relative occurrence of advertisements or e-mail spam.

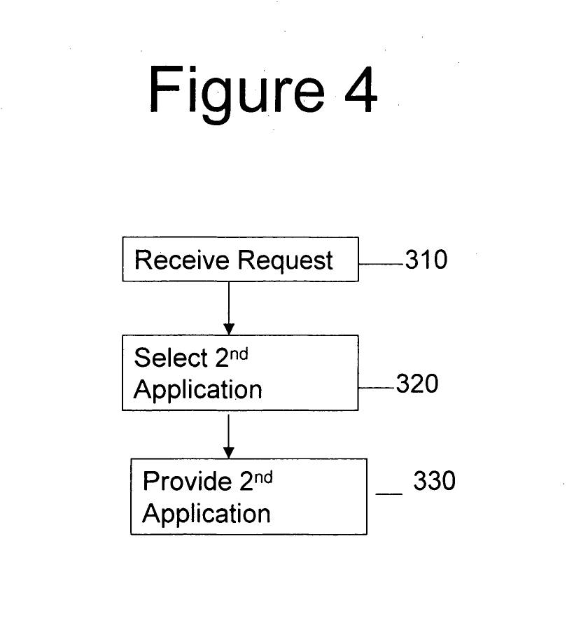

FIG. 4 shows steps used to perform the application switching. In step 310, the ASC 110 receives a request for a first software application, a general request for an application, or a request for content. In step 320, the ASC automatically selects a second application or content to fulfill the request. In step 330, the ASC provides the second software application to the requester.

In step 320, the ASC may use various rules and criteria, such as those stored in file 210 for selecting the second application. These rules may be provided by users, companies, parents, schools, or other groups. These rules may include a relatedness of a first application to a second application. For example, if a user requests a paint program, other paint programs may be offered. The relatedness also includes the notion of a different version of a requested application or an application that performs a similar function.

The rules and criterion include any of: low availability of first application, cost of first application, speed of first application, quality of first application, human factors of first application, nature of input and output for the first application (e.g. speech recognition), content and values (e.g. violence rating, which would not be appropriate for children), and nature of licenses for first application. For example, depending on the licensing terms with the vendor, or the intellectual property rights associated with the application in the target venue, a different application might be provided by the ASC. Other rules have as input: operating system of first application, language of first application (e.g. text is in German), desire to broaden a customer's experience, collecting market data (e.g. customer feedback), vendor of the application, and export regulations that may related to encryption level and content. Customization levels of the product may be considered. For example, packages may provide different clip art, and features such as spell checking. The topic, style, reading level, cost, appropriateness, votes by other users, and ratings may be considered. If the first application is unavailable, an alternate may be provided. If the first application is slow over a slow network connection, an alternate may be provided. If the first application costs over N dollars, an alternate may be provided. If the first application has more than N advertisements, an alternate may be provided. If the first application is less secure, an alternate may be provided.

In step 320, the ASC may select a second application based on a bidding auction for applications. If the first application is unreliable or predicted to be unreliable, an alternate may be provided. If the first application is not easy to use, an alternate may be provided. If the first application is difficult to understand (e.g., has high cognitive load due to language of material presented), an alternate may be provided. If the first application has more than N advertisements or incidences of e-mail spam or adware, an alternative may be provided. If a virus or phishing is detected that is associated with an application, an alternate may be automatically provided, and the user may be notified why an alternative is provided.

The second application may be an “upgrade” to the first application (e.g. speech enabled version and installation of the ViaVoice® speech recognition program of International Business Machines Corporation.)

The application providing may be performed on a network such as the Internet, wireless (including infrared link), an intranet, Bluetooth, 802.11.

When making the selection of the second application in step 320, the ASC may also first determine a cost to the ASP of providing alternative services. For example, before providing the application in step 330, the ASP can check on how many unused seats are available, and if there are few or no seats available, a substitute application is provided. Other costs may include network bandwidth loads, the processing or memory requirements for using the software, and an assessment of that cost in the context of current workload. A similar approach can be applied to the implications of using one package versus another based on bandwidth use. For example, if network traffic is high, the ASP can select an application with lower bandwidth requirements.

Also in step 320, the ASP may determine the profit (for the ASP) of providing the application. This determination examines the price for the service and the cost, given environmental issues such as server workload and bandwidth capacity. In step 320, the ASP may also determine the predicted user satisfaction level of providing the application. This determination may be performed by an analysis of past user utilization of applications, based on statistics and/or surveys.

Applications 120 may be: application software, text files, images, video, streaming video/audio, or electronic books. The rules 250 used in step 320 may be based on any of: a lottery selection (e.g. a random awarding of the application to the customer), number of times a customer visits the ASP's web site exceeding a threshold (e.g. encourages users to browse the ASP's web site because they may get a reward, such as the use of an application for a period of time), total usage of the ASP by the customer or an individual user (this may be thought of as somewhat analogous to a flight upgrade in a frequent flyer program). Thus, for example, each time the user visits the ASP's Web site, that user is entered in a weekly “drawing”, or each time the user visits the ASP Web site the user has “punched” a virtual card that gives the user a reward for frequent visits within a specified period of time.

In one embodiment of the present invention, ASPs may provide software that a user has not actually requested in an application-server embodiment. One motivation for this arises from the ASPs desire to control their costs. Occasionally, it will be useful for the ASP to substitute an alternate application, and this substitution may permit the service to reduce rates. For example, a customer requests Adobe PhotoShop 5, but for some reason this is unavailable or expensive during the week of August 1st. Thus, the ASP automatically sends an alternative such as PaintShop Pro or PhotoShop 4.

A school system may request educational software or content and automatically be sent an alternative based on various criteria such as topic, style, reading level, cost, appropriateness, votes by other users, and/or ratings. A user may request entertainment software or content, including game software and movies, and automatically be sent an alternative based on various criteria such as topic, style, cost, appropriateness, votes by other users, and/or ratings. One motivation for this is that the customer may wish to sign up to always get free or the lowest cost software because (s)he is on a strict budget. Another motivation is that the alternative may arrive quickly when the first selection is not available quickly. Customers may specify rules, such as “always prefer Microsoft products.” If they already have the Microsoft product Word, then they may wish to use Microsoft PowerPoint for presentations. If not available, then they will accept the next best thing, or the package with the closest features.

A third party may set such rules that control application switching or interact with the rules set by customers and suppliers. For example, a parent, company, or school may supply a set of rules that enable the automatic providing of an alternative when a first request for software or content is made by a user. Various novel criteria may be used to determine when to switch from one application or content to another application or content: low availability of first application, cost of first application, speed of first application, quality of first application, and human factors of first application. For example, it may be important to consider whether or not the application is acceptable for the handicapped. If the application is not enabled for the visually impaired, the application services controller (ASC) automatically finds an alternative that is accessible for the handicapped. An application may be switch based on content and values. For example, a parent may want the ASP to substitute content if the requested content is inappropriate. An application switch may occur based on the nature of licenses for first application; for example, the licensing terms with the vendor, or the intellectual property rights associated with the application in the target venue, may determine that a different application will be provided. An application switch may occur based on: operating system of first application, language of first application (e.g. text is in German), desire to broaden a customer's experience, the desire to collect market data (e.g. customer feedback), vendor of the application, export regulations (e.g. if application is being used abroad, don't use 128 bit encryption), customization of the product (e.g. changes in clip art provided, changes in the features provided—i.e. use a “lite” version without certain tools like hyphenation or spell checking in a word-processor under certain conditions). The customer may enjoy new experiences and thus provide a rule that permits the ASP to provide applications that will enrich and educate the user.

The application/content switching provider may be any of: a third party, the provider of the first application or service, the provider of the second application or service, the provider of both applications or services, a software agent running on the user's computer, a service provider, company, government, photo provider, music provider, image provider, insurance agency, health provider, advertiser, TV Guide, broadcaster, e-book provider, music provider, or game provider.

Also in accordance with the invention, the application switching provider may receive a fee from the user, and this fee may depend on the nature of information or application presented, amount of information presented, the nature of the service, the number of times switching is used, quality of service, or user satisfaction level. The user satisfaction level may be determined automatically, for example by biometrics. The user may be an individual or group of individuals (for example, a company, county, or a state).

As one example, a student or teacher is using an educational software package (or requests an educational application), which suddenly fails to perform properly. Various criteria may be used to determine when switching from one application to another is appropriate, including such considerations as: application is unavailable, application is degraded (e.g. bandwidth is low), cost of application 2 is less than application 1, application 2 has fewer advertisements, application 2 is more secure, results of a bidding (auction) system for applications, an assessment of potential/predicted relative liability, predicted reliability of application over the next N hours, relative ease of use for a plurality of providers (e.g. user experience) using application 1 versus application 2, relative cognitive load (e.g. language of material presented) for the applications, and relative occurrence of e-mail spam.

Because the application switching provider has some knowledge of the user of the system, it may be advantageous for the application switching provider to send relevant promotional and informative material to the user, such as why the switch was made, and when the switch took place.

In a second embodiment, application selection depends upon a lottery; for example, customers may be part of a reward lottery. The ASP may sometimes reward good customers by sending an application to try for free, as part of a lottery. There can be benefits to the ASP for familiarizing customers with new applications and benefits to the customers as well. There may also be benefits to the application sellers as well, because people will be trying new products.

The content provided is generally provided to a source of the request. However, it is possible for a system administrator, or other supervisory authority to make the request, and for an actual user to receive the content.

Variations described for the present invention can be realized in any combination desirable for each particular application. Thus particular limitations, and/or embodiment enhancements described herein, which may have particular advantages to the particular application need not be used for all applications. Also, it should be realized that not all limitations need be implemented in methods, systems and/or apparatus including one or more concepts of the present invention.

The present invention can be realized in hardware, software, or a combination of hardware and software. Any kind of computer system-or other apparatus adapted for carrying out the methods and/or functions described herein-is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system-is able to carry out these methods. Computer program means or computer program in the present context include any expression, in any language, code or notation, of a set of instructions intended to cause a system having an information processing capability to perform a particular function either directly or after conversion to another language, code or notation, and/or reproduction in a different material form.

Thus, the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. The concepts of this invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art. Thus, it should be understood that the embodiments has been provided as an example and not as a limitation. The scope of the invention is defined by the appended claims.

What is claimed is:

1. A programmed method for supplying content, comprising:
receiving via a network, a request for a first content for use on a device;
selecting, automatically, a second content to fulfill said request; and
providing said second content.

2. The programmed method of claim 1, wherein said providing is to a source of said request.

3. The programmed method of claim 1, wherein said device is a computer.

4. The programmed method of claim 1, wherein said first content and said second content are any one of software applications; a service; text files, images, video, streaming video/audio, and electronic books.

5. The programmed method of claim 1, wherein said selecting is performed in accordance with predetermined criteria.

6. The programmed method of claim 5, wherein said criteria include predetermined rules.

7. The programmed method of claim 5, further comprising receiving information defining at least one criterion from at least one requester.

8. The programmed method of claim 5, wherein the criteria are based on a relatedness of said first content and said second content.

9. The programmed method of claim 8, wherein the relatedness is any of:
a different version of the content; and
content that performs a similar function.

10. The programmed method of claim 5, wherein the criteria include, with respect to the first content or the second content any of: availability; cost to a provider; cost to a user; profit margin; speed; quality; human factors; whether the content is objectionable; nature of licenses; operating system; hardware requirements; memory requirements; language; broadening of a customer's experience; collecting market data; vendor of content; export regulations; customization of content; required bandwidth; server workload; availability of bandwidth; availability of seats under a license; security; relative liability; predicted reliability; ease of use; relative cognitive load; sophistication of user; availability of a bidding on cost; topic; style; reading level; votes by other users; ratings by other users; occurrence of advertising; and occurrence of spam.

11. The programmed method of claim 5, wherein the criteria comprise any of:
a lottery selection;
a number of times a customer visits a web site; and
total usage by the customer or an individual user.

12. The programmed method of claim 1, wherein the second content is an upgrade of the first content.

13. The programmed method of claim 1, the network is one of: Internet, wireless, intranet, Bluetooth, 802.11.

14. The programmed method of claim 1, wherein the selecting is performed by at least one of:
a provider of the first content;
a provider of the second content;
a the provider of both contents;
a software agent running on the user's computer;
a service provider; and
a third party other than the requester or a provider.

15. The programmed method of claim 1, wherein the selecting is performed by at least one of: a business entity; a government; a photo provider; a music provider, an image provider; an insurance agency; a health provider; an advertiser; a television program listing provider; a broadcaster; and a game provider.

16. The programmed method of claim 1, wherein said request is fulfilled via a network.

17. A programmed method for obtaining content, comprising:
requesting via a network a first content for use on a device; and
receiving an automatically selected second content to fulfill said request.

18. The programmed method of claim 17, wherein said device is a computer.

19. The programmed method of claim 17, wherein said first content and said second content are any one of software applications; a service; text files, images, video, streaming video/audio, and electronic books.

20. The programmed method of claim 17, wherein said second selected content is selected in accordance with predetermined criteria.

21. The programmed method of claim 20, wherein said criteria include predetermined rules.

22. The programmed method of claim 21, further comprising providing information defining at least one criterion from at least one source of said request.

23. The programmed method of claim 20, wherein the criteria are based on a relatedness of said first content and said second content.
